(19) United States
(12) Patent Application Publication
(10) Pub. No.: US 2023/0276767 A1
(43) Pub. Date: Sep. 7, 2023

(54) MODULAR ANIMAL BED

(71) Applicant: Julie Bohm, Seattle, WA (US)

(72) Inventor: Julie Bohm, Seattle, WA (US)

(21) Appl. No.: 18/175,387

(22) Filed: Feb. 27, 2023

Related U.S. Application Data
(60) Provisional application No. 63/315,347, filed on Mar. 1, 2022.

(51) Int. Cl. A01K 1/035

(52) U.S. Cl. CPC A01K 1/0353

(57) ABSTRACT

A modular animal bed includes a base and sidewalls coupled to the base to define a cavity. One or more inserts are positionable in the cavity to separate the cavity into a first cavity and a second cavity. An animal can lay on the insert or the sidewalls to provide support for their spine and hips. The bed may further include a removable and washable cover on the base, the sidewalls, and the insert.

### BACKGROUND

### Technical Field

The present disclosure is directed to an animal bed and is particularly, but not exclusively, directed to a modular animal bed.

### Description of the Related Art

Beds for animals are known. Common examples include a dog bed or a cat bed, which are typically a rectangular or circular pad that allows an animal to lay comfortably on an otherwise hard and uncomfortable floor surface. However, known animal beds suffer from a number of disadvantages.

For example, known beds are not particularly well suited for animals with certain health issues, such as spinal issues and hip dysplasia, because the beds are a flat pad that does not provide proper support for the animal. In addition, known beds are not adjustable to account for animals with different health conditions or preferred sleeping positions. Thus, it would be advantageous to have an animal bed that overcomes the above and other disadvantages of the related art.

### BRIEF SUMMARY

The present disclosure is generally directed to a modular animal bed. The bed has a flat base with sidewalls extending from the base to define a central cavity. An insert is positioned in the cavity and extending between two of the sidewalls to separate the cavity into a first cavity and a second cavity. The insert may be permanently coupled to the sidewalls or removably coupled to the sidewalls and adjustable within the cavity. Where the insert is adjustable, the position of the insert can be changed to vary the size and shape of the first cavity and the second cavity according to the needs or size of an animal. As a result, an animal can lay with their stomach on the insert to support their spine or hips and their legs resting over the sidewalls or in the cavities, or both. Animals without health concerns may also find the design of the modular beds described herein to be comfortable for normal use. The animal bed may also include additional inserts structured to be received in the first cavity or the second cavity, or both, that enable other configurations as well, including a flat or recessed area for sleeping in addition to an area with a cavity for supporting the animal, among other possible configurations.

In one or more embodiments, a modular animal bed may be summarized as including: a base; a plurality of sidewalls coupled to the base; a cavity defined by the plurality of sidewalls and the base; and an insert in the cavity and extending between two of the plurality of sidewalls.

The bed may further include: the base, the plurality of sidewalls, and the insert being foam; a first removable cover on the base and the plurality of sidewalls; a second removable cover on the insert; a pad positionable in the cavity between the plurality of sidewalls and the insert, the pad having a rectangular or square shape with a first surface and a second surface, the first surface proximate the base and the second surface aligned with the plurality of sidewalls; the insert being removable and positionable in the cavity to separate the cavity into a first cavity and a second cavity; the insert being permanently coupled to the plurality of sidewalls, or the base, or both; the insert being integral with the base and the plurality of sidewalls as a single, unitary structure.

In one or more embodiments, a bed may be summarized as including: a base; a plurality of sidewalls coupled to the base, each of the plurality of sidewalls including a first surface and a second surface opposite to the first surface; a cavity defined by the plurality of sidewalls and the base; and an insert positionable in the cavity to extend between two of the plurality of sidewalls to separate the cavity into a first cavity and a second cavity, the insert having a first surface positionable on the base and a second surface opposite to the first surface.

The bed may further include: the second surface of the insert being coplanar with the second surface of the plurality of sidewalls; the second surface of the insert being recessed with respect to the second surface of the plurality of sidewalls; the insert having a cross shape positionable in the cavity between four of the plurality of sidewalls; an aperture in at least one of the plurality of sidewalls, the aperture extending from the second surface of the at least one of the plurality of sidewalls to the base; the insert being permanently coupled to the plurality of sidewalls or the base; the insert being a first insert, the bed further comprising a second insert positionable in the first cavity or the second cavity; the second insert being a rectangular divider or a square pad; the second insert having a triangular shape; a removable cover on the base, the plurality of sidewalls, and the insert; and a first removable cover on the base and the plurality of sidewalls and a second removable cover on the insert.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive embodiments are described with reference to the following drawings, wherein like labels refer to like parts throughout the various views unless otherwise specified. The sizes and relative positions of elements in the drawings are not necessarily drawn to scale in some figures. For example, the shapes of various elements are selected, enlarged, and positioned to improve drawing legibility. In other figures, the sizes and relative positions of elements in the drawings are exactly to scale. The particular shapes of the elements as drawn may have been selected for ease of recognition in the drawings. The figures do not describe every aspect of the teachings disclosed herein and do not limit the scope of the claims.

FIG. 1A is an isometric view of an embodiment of a modular animal bed with a first insert according to the present disclosure;

FIG. 1B is an exploded isometric view of the modular animal bed of FIG. 1A;

FIG. 1C is an isometric view of an embodiment of a cover of the modular animal bed of FIG. 1A;

FIG. 2 is an isometric view of the modular animal bed of FIG. 1A with a second insert;

FIG. 3A is an isometric metric view of the modular animal bed of FIG. 1A with a pad;

FIG. 3B is an exploded isometric view of the modular animal bed of FIG. 3A;

FIG. 4 is a plan view of the modular animal bed of FIG. 1A with the first insert having a cross shape;

FIG. 5 is an isometric view of the modular animal bed with a second triangular insert;

FIG. 6 is an isometric view of an embodiment of a modular animal bed with sidewall supports and a pad portion; and

FIG. 7 is an isometric view of an embodiment of a modular animal bed with an aperture on at least one side of the bed.

FIG. 8 is an isometric view of an embodiment of a modular animal bed with an oval shape and a raised bed.

FIG. 9 is an isometric view of an embodiment of a modular animal bed with a step up configuration.

FIG. 10 is an isometric view of an embodiment of a modular animal bed with an offset support.

FIG. 11 is an isometric view of an embodiment of a modular animal bed with a circular shape.

FIG. 12 is an isometric view of an embodiment of a modular animal bed with a pad portion and multiple supports.

### DETAILED DESCRIPTION

Persons of ordinary skill in the art will understand that the present disclosure is illustrative only and not in any way limiting. Other embodiments of the presently disclosed system and method readily suggest themselves to such skilled persons having the assistance of this disclosure.

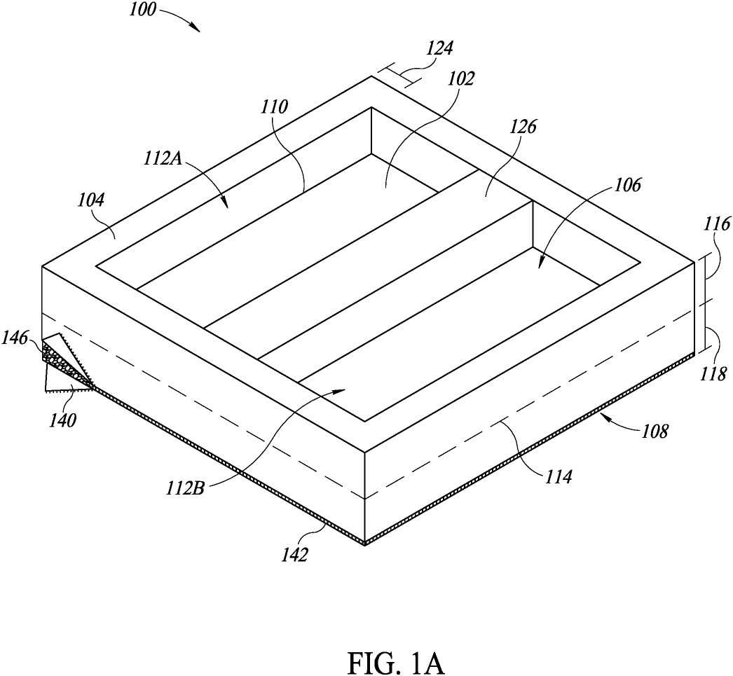

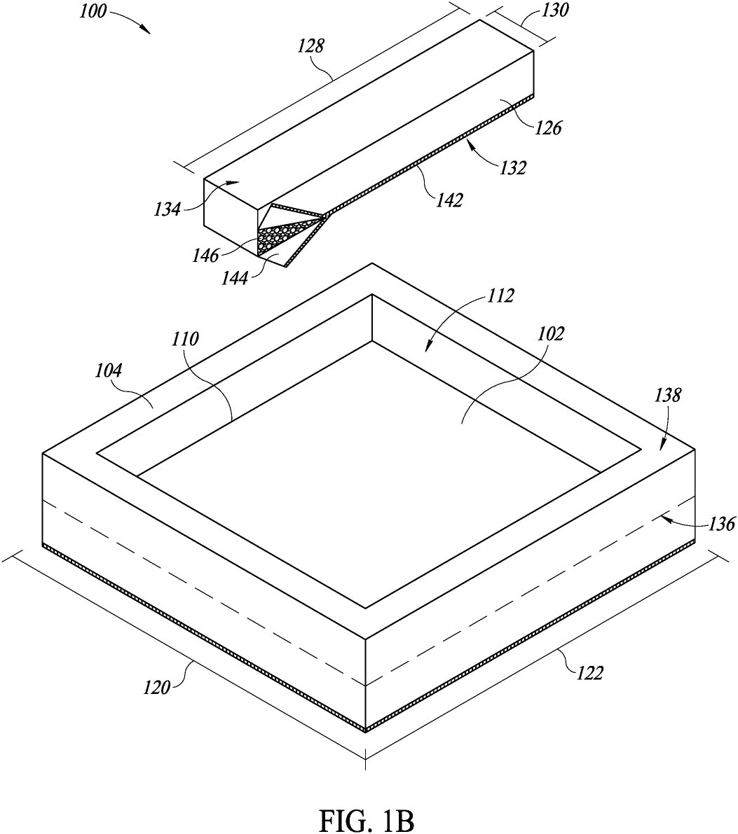

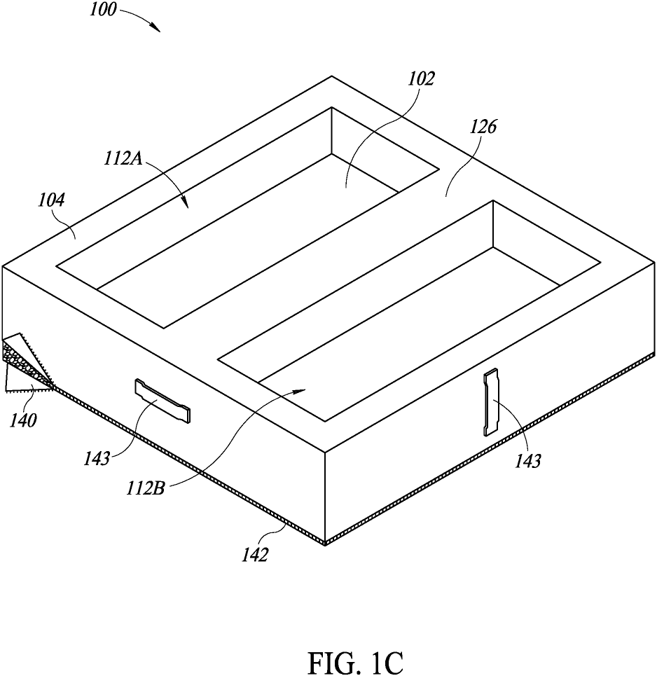

Each of the features and teachings disclosed herein can be utilized separately or in conjunction with other features and teachings to provide modular animal bed devices, systems, and methods. Representative examples utilizing many of these additional features and teachings, both separately and in combination, are described in further detail with reference to attached FIG. 1A-12. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present devices, systems and methods.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced, but are not intended to limit the dimensions and the shapes shown in the examples in some embodiments. In some embodiments, the dimensions and the shapes of the components shown in the figures are exactly to scale and intended to limit the dimensions and the shapes of the components.

In general, the present disclosure is directed to a modular animal bed with inserts and removable supports to provide additional supports configurations for animals with a number of different health issues. Although embodiments of the disclosure will describe a dog bed in one size in a non-limiting example, it is to be appreciated that the concepts of the disclosure can be applied equally to animal beds of different sizes and shapes as well as beds that are intended for other animals besides dogs. Thus, the use of a dog bed as a non-limiting example in the below description does not limit the disclosure or the claims.

FIG. 1A is an isometric view of a modular animal bed 100 (which may be also be referred to as a dog bed 100 or a bed 100). FIG. 1B is an exploded view of the bed 100. With reference to FIG. 1A and FIG. 1B, the bed 100 includes a base 102 and a plurality of sidewalls 104 coupled to the base 102. The base 102 includes a first surface 106 and a second surface 108 opposite to the first surface 106. In some embodiments, the first surface 106 is a top surface and the second surface 108 is a bottom surface. Each of the surfaces 106, 108 may generally be flat and planar with the base 102 having a selected shape, including a square, rectangle, circle or oval in some non-limiting examples. In one or more embodiments, the surfaces 106, 108 may have protrusions associated with a material of the base 102 (such as foam protrusions) or the surfaces 106, 108 may have a selected shape to provide support for an animal. The base 102 has an outermost edge or perimeter 110 extending around the surfaces 106, 108. In some embodiments, the plurality of sidewalls 104 are coupled to, and extend from, the perimeter 110 of the base 102. Thus, the sidewalls 104 are disposed on the base 102 and extend around an entirety of the base 102 to define a cavity 112 best shown in FIG. 1B. Alternatively, the sidewalls 104 may define the perimeter 110 of the base 102 and extend from the first surface 106 to the second surface 108 of the base 102. In other words, the base 102 may be an insert positionable between the sidewalls 104 to define the cavity 112 in one or more embodiments.

The sidewalls 104 may be integral with the base 102 as a single unitary structure, or the sidewalls 104 may be one or more separate structures permanently or removably coupled to the base 102 in some embodiments. Dashed line 114 in FIG. 1A and FIG. 1B represents the interface between the base 102 and the sidewalls 104 in embodiments where the sidewalls 104 sit on top of the base 102. In such an arrangement, the sidewalls 104 have a height 116 that may be greater than, less than, or equal to a height 118 of the base 102. In a preferred embodiment, the height 116 of the sidewalls 104 is equal to the height 118 of the base 102 with the heights 116, 118 being 3 inches or approximately 3 inches. In an embodiment where the sidewalls 104 surround the base 102, the sidewalls 104 may have a height that is a combination of heights 116, 118 and is preferably between 3 inches and 12 inches, and more preferably about 6 inches. Further, the base 102 and the sidewalls 104 have outer dimensions 120, 122, such as a length and a width, respectively, with dimension 120 being 24 inches or approximately 24 inches and dimension 122 being 23.5 inches or approximately 23.5 inches in the illustrated embodiment of FIG. 1A. The dimension 120 or length of the bed 100 may also be about 25 inches to 35 inches, and more preferably about 29 inches. The dimension 122 or width of the bed 100 may be about 20 inches to 30 inches, and more preferably about 25 inches in a preferred embodiment in order to enlarge and widen the cavity 112. The dimensions 120, 122 above may be interchangeable such that the dimension 120 is about 25 inches and the dimension 122 is about 29 inches in a preferred embodiment. While the sidewalls 104 may have any selected shape, FIG. 1A and FIG. 1B illustrate a non-limiting embodiment where the sidewalls 104 are generally rectangular with square or sharp edges. The sidewalls 104 may also be rounded in some embodiments. Further, the sidewalls may have a thickness 124 that is two inches to four inches, or approximately 2.5 inches in a preferred embodiment.

Further, the bed 100 may include a first insert 126 positionable in the cavity 112 to separate the cavity 112 into a first cavity 112A and a second cavity 112B, as shown in FIG. 1A. The insert 126 may generally have a rectangular shape with a length 128 that corresponds to a distance across the cavity 112. In an embodiment where the dimension 122 is about 25 inches, the length 128 of the insert 126 may be about 20 inches such that the insert 126 is received in contact with interior faces of the sidewalls 104. The insert 126 may have any selected width or thickness 130, such as between 1 inch and 10 inches or more or less, and more preferably approximately 4 inches in some non-limiting examples. Thus, the insert 126 is wider or thicker than the sidewalls 104 in some embodiments to provide additional support for an animal laying on the insert 126 and resist compression in response to an animal laying on the insert 126. Alternatively, the thickness 130 of the insert 126 may be the same as, or less than, the thickness 124 of the sidewalls 104. The length 128 of the insert 126 is selected so that the insert 126 extends across the entirety of the cavity 112 and contacts two opposing sidewalls 104 of the plurality of sidewalls, as shown in FIG. 1A. The insert 126 may have a height that is equal to, greater than, or less than the height 116 of the sidewalls 104. In an non-limiting example, the insert 126 has a height between 1 inch and 10 inches, and more preferably about 3 inches so that a top surface of the insert 126 is coplanar and aligned with the top surface of the sidewalls 104 in response to the insert 126 being received in the cavity 112. More specifically, the insert 126 has a first or bottom surface 132 and a second or top surface 134 opposite to the first surface 132. The sidewalls 104 have a first or bottom surface 136 proximate to, or disposed in direct contact with the base 102 and a second or top surface 138 opposite to the first surface 136. The second surface 134 of the insert 126 is coplanar and aligned with the second surface 138 of the sidewalls 104, as shown in FIG. 1A.

It is to be appreciated that the specific dimensions described above for the various aspects of the bed 100 are non-limiting and that in practice, the dimensions can be selected and may be more or less than the stated values. For example, the dimensions of the bed 100 may be adapted for animals of different sizes, such as the dimensions being greater for a larger bed 100 for a larger dog or the dimensions being less than those stated above for a smaller bed 100 for smaller dogs or cats, among other animals. The dimensions may also be selected to be different than those above based on other factors, such as manufacturing and design preferences, among others.

In some embodiments, the insert 126 is removably coupled to the bed 100 by a friction fit between ends of the insert 126 and the sidewalls 104. Thus, the position of the insert 126 relative to the sidewalls 104 and the cavity 112 can be selected to vary a size of the first and second cavities 112A, 112B. The first and second cavities 112A, 112B may have the same size and shape in some embodiments, or the first cavity 112A may be larger or small than the second cavity 112B based on the selected position of the removable insert 126. In one or more embodiments, the insert 126 is permanently coupled to the sidewalls 104 of the bed in a selected position. For example, the insert 126 may be permanently coupled to the sidewalls 104 across a center of the bed 100 (i.e., the insert is positioned equidistant from the sidewalls 104 to the left and right of the insert 126 in the orientation shown in FIG. 1A) such that the first and second cavities 112A, 112B have the same size and shape in a preferred embodiment. Based on the preferred dimensions discussed above, the position of the insert 126 through the center of the cavity 112 results in 9 inches or approximately 9 inches of spacing between either side of the insert 126 and the sidewalls 104.

The bed 100 may further include a first cover 140 on the base 102 and the sidewalls 104. In some embodiments, as in FIG. 1A, the first cover 140 is also on the insert 126. The first cover 140 is removable, as indicated by a portion of the cover being open in FIG. 1A, and is machine washable for convenience. The cover 140 may be removably coupled or removably disposed on the bed 100 with a zipper 142 extending around at least one side, at least two sides, or at least three sides of the base 102 as in FIG. 1A. In a preferred embodiment, the zipper 142 extends along an entirety of two sides of the base 102 at an interface between the bottom and side surfaces of the base 102. In some embodiments, as in FIG. 1B, a separate, second removable and machine washable cover 144 is on the insert 126 with the first cover 140 being only on the base 102 and the sidewalls 104. The second cover 144 likewise has a zipper 142 extending along an entirety of at least one side of the insert 126 at an interface between the bottom and side surfaces of the insert 126. The base 102, the sidewalls 104, and the insert 126 may also be a selected type of material 146. The material 146 can include foam, such as polyurethane foam, open cell memory foam, closed cell memory foam, gel memory foam, latex foam, gel foam, reflex foam, latex rubber foam, convoluted foam, evlon, latex, and the like, in some non-limiting examples. The material 146 may also be selected to be a different material, including but not limited to any commercially available padding or stuffing material for cushions, pads, beds, pillows, furniture, and other like items. The covers 140, 144 described herein may also have a selected material, including but not limited to, canvas, polyester blends, polyethylene, cotton, nylon, microfiber, and other like materials, or a combination thereof, and may or may not be a waterproof or water-resistant material. In an embodiment, the covers 140, 144 are made from any commercially available material now known or developed in the future, including without limitation materials for furniture covers and materials for animal bed covers. In one or more embodiments, the covers 140, 144 include may be an arrangement of two layers with one layer being a material that is not waterproof or water-resistant and a second layer that fits over the first layer and has waterproof or water-resistant qualities.

In operation, and with reference to FIG. 1A, an animal lays with their stomach on the insert 126 in order to provide support for the animal’s spine and hips. The animal’s back legs may hang over sidewalls 104 and extend outside of the bed 100 while the animal’s front legs rest in the cavities 112A, 112B. The bed 100 may also be used by animals without health concerns simply for comfort, with the insert 126 and sidewalls 104 providing support for comfort of the animal in different sleeping positions. Alternatively, the insert 126 can be positioned to provide one larger cavity 112A, 112B and one smaller cavity 112A, 112B. The smaller cavity can be used in the manner above to support an animal’s spine and hips while the larger cavity enables the animal to lay comfortably on the base 102 in a normal sleeping position. In further examples, multiple animals may use the same bed 100 by lying with their hips on the sidewalls 104, their back legs hanging over the sidewalls 104 and extending outside of the bed 100, and the remainder of their respective bodies received in respective cavities, such as one animal utilizing cavity 112A and one animal utilizing cavity 112B. Other configurations are contemplated herein. Thus, the modular nature of the bed 100 as well as its unique design provides support for animals with certain health concerns, including spinal issues, that overcomes the disadvantages of known animal beds.

FIG. 1C is an isometric view of an embodiment where the bed 100 includes the insert 126 permanently coupled to the sidewalls 104 to define the first and second cavities 112A, 112B. As noted above, the bed 100 may include a removable first cover 140. In an embodiment where the insert 126 is permanently coupled to the sidewalls 104, the first cover 140 may have a size, shape, and arrangement that mirrors the features of the bed 100, which is to say that the cover 140 is customized to the shape of the bed 100 and likewise includes sidewalls, cavities, and the like corresponding to the sidewalls 104, cavities 112A, 112B, and insert 126, among others, of the bed 100 described above. Further, in embodiments where the insert 126 is removable or permanently coupled to the sidewalls 104, the cover 140 may include handles 143 on an outer surface of the cover 140. The handles 143 may be arranged horizontally or vertically, as shown in FIG. 1C. Preferably, the bed 100 includes two handles 143 arranged on opposite surfaces to assist with carrying the bed 100 from both opposite sides. The opposite sides may be, for example, a front and rear side or a left and right side.

Although the handles 143 are illustrated as only a single handle 143 on only a front side and a right side of the bed 100, it is to be appreciated that the rear and left sides may include one or more handles 143 and that the number and arrangement of the handles 143 can generally be selected according to design factors such as the size and weight of the bed 100, among others. For example, the bed 100 may include more than one handle 143 on only two opposite sides, a selected number of handles 143 on each side in a selected spacing or arrangement relative to each other, each handle 143 having the same or a different orientation (i.e., horizontal, vertical, or some other orientation) as the other handles 143 on each side as well as on the bed 100 generally, the handles 143 centered on the respective side surfaces of the cover 140 or positioned in a selected location on the side surfaces of the cover 140, among other possibilities. In a non-limiting example, the bed 100 may include two handles 143 on two opposite sides of the bed 100. Further, the zipper 142 may be located around at least peripheral edges of the front and right sides, or other selected sides and locations on the cover 140. The zipper 142 may also be replaced by other fastening devices and methods, such as buttons, snaps, hook and loop fasteners, and the like.

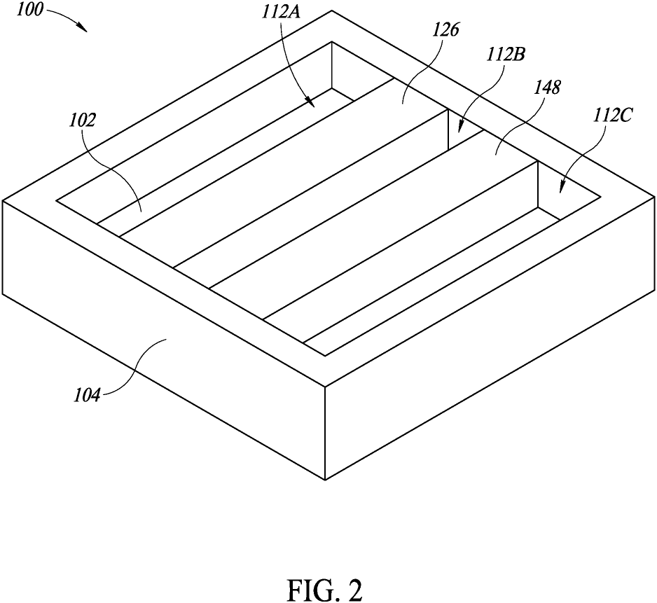

FIGS. 2-5 are views of additional embodiments of the bed 100 with different numbers and arrangement of inserts. Beginning with FIG. 2, the bed 100 may include a second insert 148 in addition to the base 102, the sidewalls 104, and the first insert 126 described above. The second insert 148 may be identical to the first insert 126 in some embodiments. Thus, the insert 126, 148 are positionable in the cavity 112 (FIG. 1B) to separate the cavity 112 (FIG. 1B) into the first cavity 112A, the second cavity 112B, and a third cavity 112C. The second insert 148 may enable two animals to lay on the bed 100 simultaneously in the manner described above, namely resting with their stomachs on the inserts 126, 148 to provide support for the spine and hips.

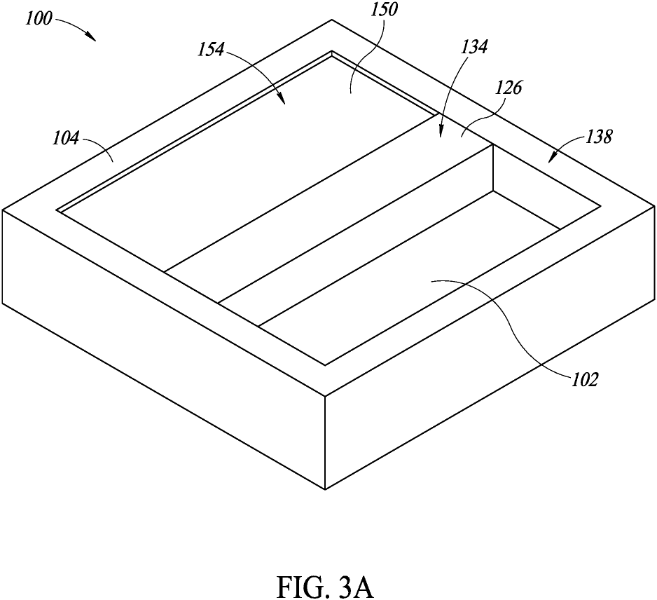

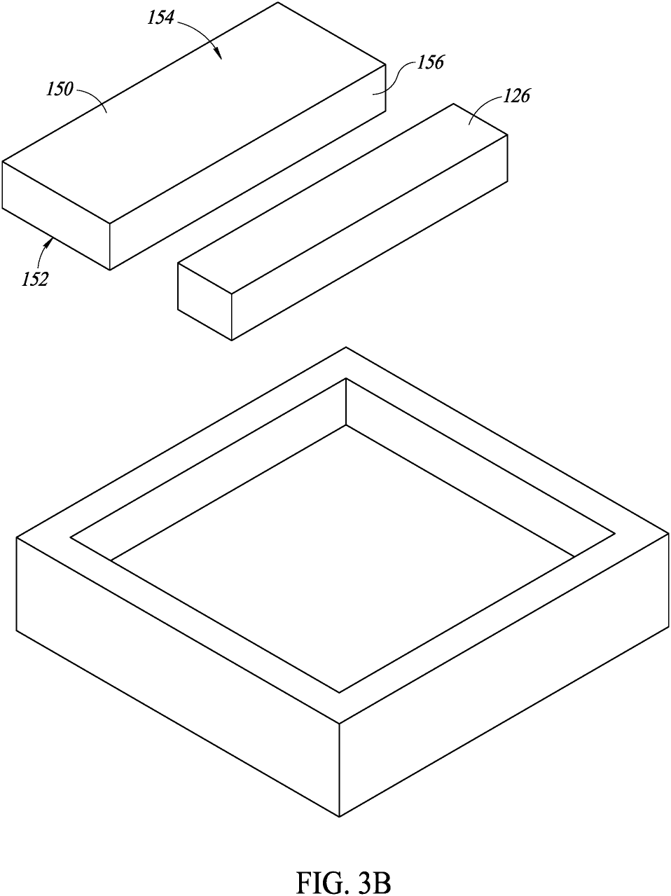

In some embodiments, the bed 100 includes an additional insert that is not identical to the first insert 126, but rather, has a different shape and purpose. For example, FIG. 3A is an isometric metric view of the modular animal bed 100 with a pad 150. FIG. 3B is an exploded view of the bed 100 from FIG. 3A for additional context. As shown in FIG. 3A, the bed 100 may include a pad 150 positionable in the first or second cavity 112A, 112B (FIG. 1A) to provide a flat laying surface for an animal. The pad 150 includes a first or bottom surface 152 and a second or top surface 154 opposite to the first surface 152 with sidewalls 156 extending between the surfaces 152, 154. The first surface 152 of the pad 150 is disposed on or in contact with the base 102 of the bed 100 with sidewalls 156 of the pad 150 contacting at least three of the sidewalls 104 of the bed 100 and one side of the first insert 126. The pad 150 is removably positionable in the cavities 112A, 112B (FIG. 1A) in a friction fit, or the pad 150 may be permanently coupled to the bed 100.

The second surface 152 of the pad 150 may be coplanar with or aligned with the second surface 134 of the insert 126 and the second surface 138 of the sidewalls 104 of the bed 100. The second surface 152 of the pad 150 may also be recessed with respect to the second surface 134 of the insert 126 and the second surface 138 of the sidewalls 104 of the bed 100, as shown in FIG. 3A, to provide a boundary for the pad 150 and increase the comfort of the animal laying on the pad 150. An animal may also lay across the bed 100 and pad 150 from left to right in the orientation shown in FIG. 3A with the pad 150 providing additional support for the animal’s stomach (i.e., the pad 150 acts as a wider version of insert 126 described above). Further, the pad 150 may have a selected size and shape to accommodate a cavity of a corresponding size, as described herein. For example, the pad 150 may have a size and a shape to be received in any of the first, second, and third cavities 112A, 112B, 112C (FIG. 2) in addition to other cavities, apertures, or openings described herein.

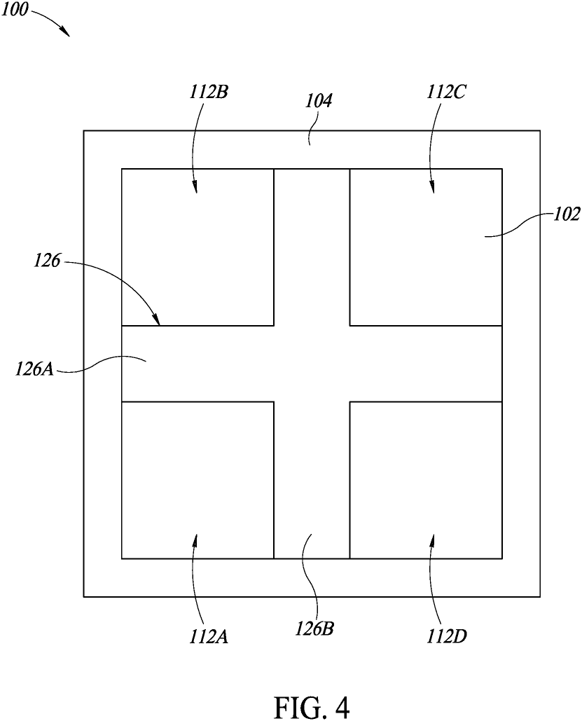

FIG. 4 is a plan view of the modular animal bed 100 with the first insert 126 having a cross shape. In particular, the first insert 126 may include a first wall 126A extending laterally (i.e., left to right in the orientation shown in FIG. 4) and a second wall 126B extending longitudinally (i.e., up and down in the orientation shown in FIG. 4). The first and second walls 126A, 126B may be arranged perpendicularly to each other and may generally have the same size and shape such that the first cavity 112 (FIG. 1B) is divided into four separates cavities 112A-112D each having the same size and shape. The walls 126A, 126B of the insert 126 may have also a different size and shape and a selected arrangement or orientation relative to each other to provide different configurations. For example, the walls 126A, 126B may be transverse to each other (i.e., at any angle not equal to 0 degrees and not equal to 90 degrees) or the first wall 126A may be positioned closer to the top sidewall 104 than the bottom sidewall 104 of the bed 100 in the orientation in FIG. 4. The insert 126 shown in FIG. 4 enables an animal to lay across the bed in either direction with support for their spine and hips, as described above.

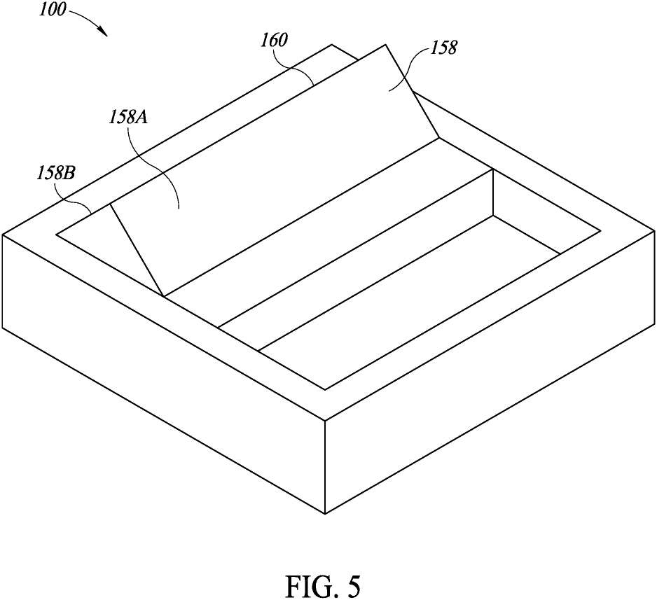

FIG. 5 is an isometric view of the modular animal bed 100 with an insert 158 having a triangular portion. The insert 158 may generally be similar to the pad 150 described with reference to FIG. 3A and FIG. 3B, except for the shape. The insert 158 may be a pentagon with a base similar to pad 150 (FIG. 3) that is adapted to be received in the first cavity or the second cavity 112A, 112B (FIG. 1A) and a triangular portion shown in FIG. 5 that is an equilateral triangle, meaning sides 158A, 158B of the triangle have the same size, shape, and orientation relative to each other in some embodiments. The triangular portion of insert 158 may also be any other type of triangle, in addition to a trapezoid or other shape. The insert 158 further includes a vertex 160 at an interface between sides 158A, 158B on which an animal can lay to provide support for their spine and hips. Because the insert 158 may be foam, the insert 158 will compress under the weight of the animal to provide a comfortable laying surface on vertex 160. Alternatively, the animal may lay on the bed 100 with their back against the first side 158A of the triangular portion to provide support for their spine from above the spine, as opposed to below the spine as with insert 126 (FIG. 1A).

In view of the above, a wide range of inserts and modular components are contemplated for the bed 100 to provide different support configurations for an animal. Other shapes and sizes of inserts not specifically illustrated are likewise contemplated, including but not limited to square inserts, trapezoidal inserts, ovular inserts, circular or cylindrical inserts, spherical inserts, inserts with rounded edges, inserts with a step-down or step-up configuration, and others.

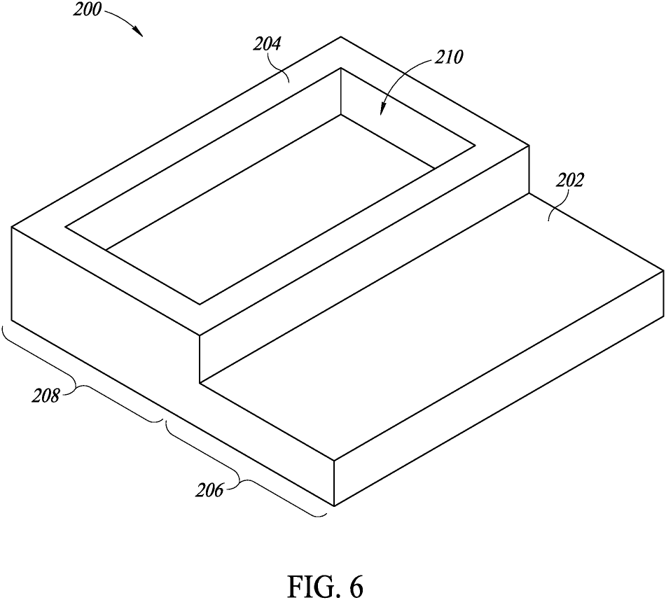

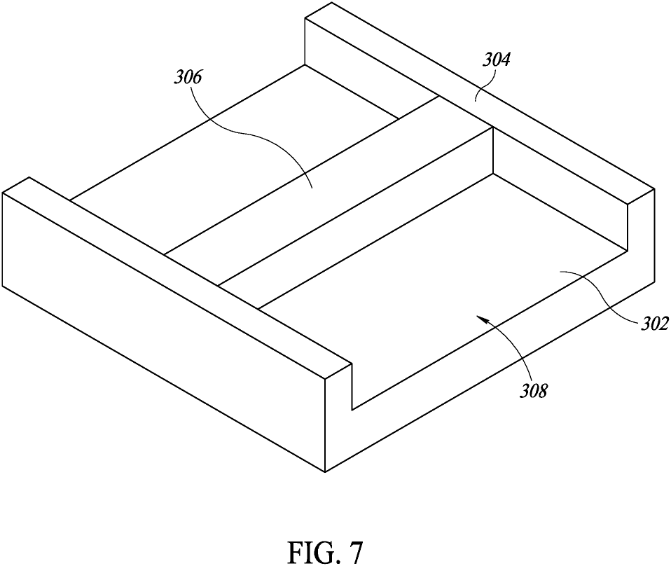

The present disclosure also contemplates different arrangements for sidewalls of a bed, as described below with reference to FIG. 6 and FIG. 7. FIG. 6 is an isometric view of an embodiment of a modular animal bed 200. The bed 200 includes a base 202 and a plurality of sidewalls 204 coupled to the base 202 similar to bed 100 described above. However, the bed 100 includes a pad portion 206 and a support portion 208. The pad portion 206 does not include sidewalls 204, but rather, is a flat and planar area on which an animal can lay. The support portion 208 includes sidewalls 204 that define a cavity 210. Although not shown in FIG. 6, the bed 200 can include any of the inserts described herein removably positioned in the cavity 210, although the same is not necessarily required, as cavity 210 may have a size and shape similar to cavities 112A, 112B defined, at least in part, by the insert 126 (FIG. 1A). Further, the sidewall 204 of the bed 200 at an interface between the pad portion 206 and the support portion 206 acts as an insert to provide support for the animal, as described further below.

Even without an insert, the sidewalls 204 extend from the base 202 in the support portion 208 of the bed 200 to provide structures on which an animal can lay to support their spine, as described herein. Although the bed 200 is illustrated in FIG. 6 as having one sidewall extending across a center of the bed 200, the position of the sidewalls 204 relative to the base 202 may be selected and thus the size and shape of the cavity 210 as well as the size and shape of the flat portion 206 and the support portion 208 may be selected. The pad portion 206 and the support portion 208 may generally be the same size and shape in some embodiments, or the pad portion 206 may be larger or smaller than the support portion 208.

FIG. 7 is an isometric view of an embodiment of a modular animal bed 300 with an aperture 308 on at least one side of the bed 300. The bed 300 includes a base 302 and a plurality of sidewalls 304 coupled to the base 302. The bed 300 may also include an insert 306 similar to the other inserts described herein, or the insert 306 may be an additional sidewall extending across a center of the bed 300. In some embodiments, at least one of the sidewalls 304 includes the aperture 308 extending through the sidewall 304 to the base 302 to enable an animal to more easily enter and exit the bed 300. Put differently, the bed 300 may include sidewalls 304 on only one, but preferably only two sides of the base 302 with the other two sides remaining open through the aperture 308. The two sides of the base 302 that include the sidewalls 304 may be opposing sides as in FIG. 7 or adjoining sides in some embodiments.

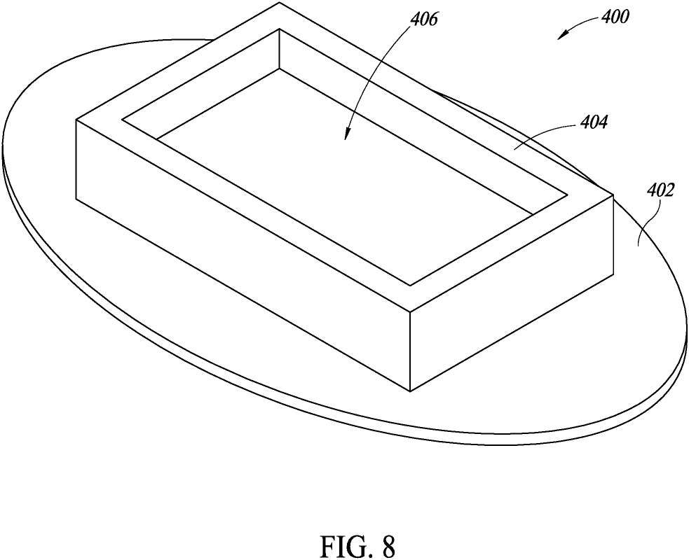

The present disclosure also contemplates different shapes and configurations of modular animal beds. For example, FIG. 8 is an isometric view of an embodiment of a modular animal bed 400 with an oval shape and a raised bed. Specifically, the bed 400 includes an oval pad or base 402 and a plurality of sidewalls 404 arranged in a rectangular shape. The sidewalls 404 extend from the pad 402 to define a cavity 406. The cavity 406 may be open, or the bed 400 may include any of the inserts described herein positioned in the cavity 406. As such, an animal can lay on the pad 402 or in the cavity 406 for comfort, or may lay on the sidewalls 404 to provide support for their spine or other target areas to address health concerns as described herein.

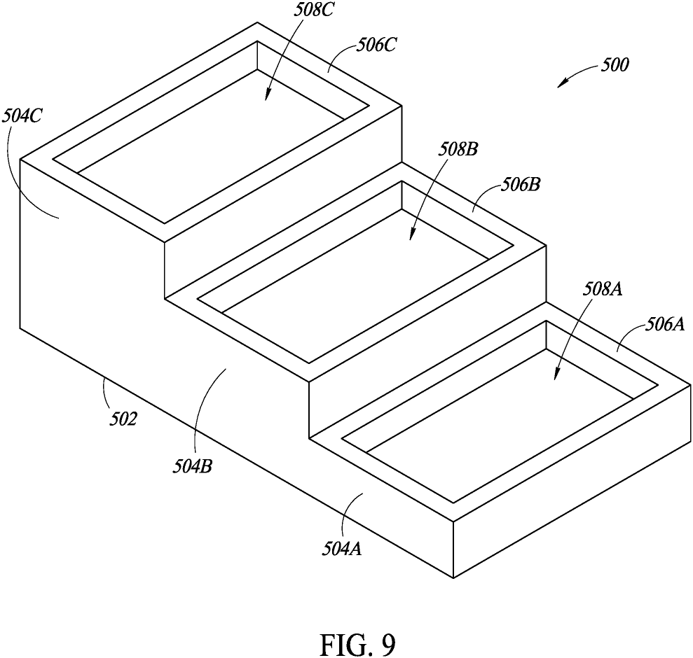

FIG. 9 is an isometric view of an embodiment of a modular animal bed 500 with a step up configuration. The bed 500 includes a base 502 having a first step 504A, a second step 504B, and a third step 504C. Although the bed 500 is illustrated in FIG. 9 as including three steps, the bed 500 may include more or less than three steps. The bed 500 includes sidewalls 506A, 506B, 506C extending from the base 502 and the steps 504A, 504B, 504C. The sidewalls 506B, 506C have a greater height relative to the base 502 than the sidewalls 506A. Similarly, the sidewalls 506C have a greater height than the sidewalls 506B. The sidewalls 506A, 506B, 506C define respective cavities 508A, 508B, 508C in each step 504A, 504B, 504C. Any of the inserts described herein may be placed in the cavities 508A, 508B, 508C. In an embodiment, one or more the steps 504A, 504B, 504C does not include the respective cavity, but rather, is a flat and planar pad that provides a comfortable laying surface for the animal. The bed 500 may also have a dual functionality as steps for an animal to access an owner’s furniture while also providing a comfortable or supportive laying surface for the animal.

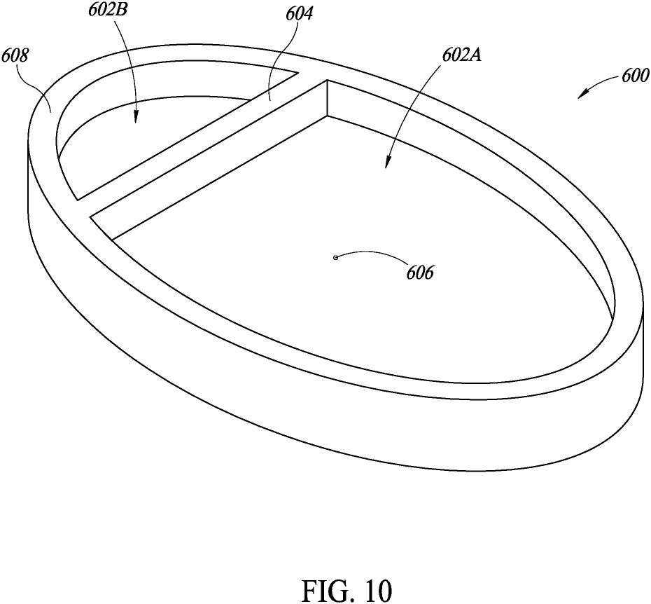

FIG. 10 is an isometric view of an embodiment of a modular animal bed 600 with an offset support. In particular, the bed 600 may have an oval shape with cavities 602A, 602B and a support 604 extending between the cavities 602A, 602B. The support 604 may be positioned offset from a center 606 of the bed 600 such that the cavity 602A is larger than the cavity 602B. The support 604 may be permanently coupled to the bed 600 as a single, integral, unitary component of sidewalls 608 that define the cavities 602A, 602B, as shown in FIG. 10. The offset support 604 provides two cavities of different shapes and sizes for different applications. For example, the larger cavity 602A may provide a comfortable laying surface for an animal to lay in the cavity 602A in a normal position (i.e., curled or on their side among other positions) or for the animal to lay resting against the support 604 to provide side or spine support. The animal can also lay on the support 604 with their legs in the smaller cavity 602B to support their spine or hips, as described herein. The cavities 602A, 602B may also be used simultaneously by animals of different sizes (i.e., a dog and a cat or dogs of different sizes). The position of the support 604 relative to the center 606 of the bed can be selected according to various factors described herein. In an embodiment, the bed 600 further includes inserts of the type described herein with a size and a shape to be received in the cavities 602A, 602B.

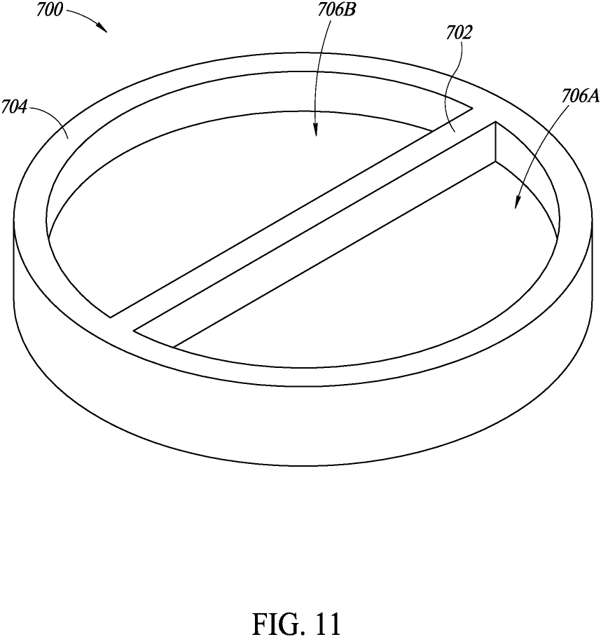

FIG. 11 is an isometric view of an embodiment of a modular animal bed 700 with a circular shape. The bed 700 is generally similar to the bed 600, except the bed 700 is circular and a support 702 of the bed 700 extends between sidewalls 704 across a center of the bed 700 to define two equal size cavities 706A, 706B. The inserts described herein can likewise be sized and shaped to be received in the cavities 706A, 706B.

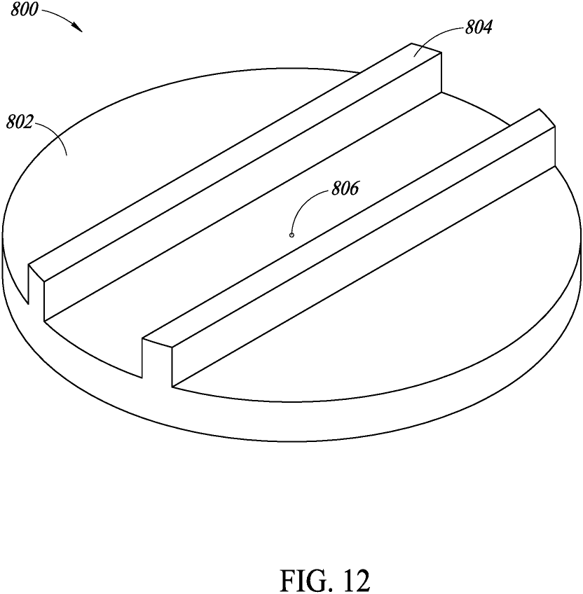

FIG. 12 is an isometric view of an embodiment of a modular animal bed 800 with a pad portion 802 and multiple supports 804. The pad portion 802 may generally be a flat, circular shape with the supports 804 extending from the pad portion 802. In an embodiment, the supports 804 are spaced equidistant, or at a selected distance, from a center 806 of the pad portion 802. The supports 804 may also be offset (i.e., each support 804 is positioned at a different distance relative to the center 806 of the pad portion 802) in some embodiments. The bed 800 may not include sidewalls around the pad portion 802, but rather, the pad portion 802 can provide a comfortable laying surface while the supports 804 enable an animal to provide support for target areas of the animal’s body, as described herein. The bed 800 may also include inserts sized and shaped to be received between or adjacent the supports 804 to provide additional laying surfaces and bed configurations.

The non-limiting examples of modular animal beds can be combined to provide further embodiments. For example, a modular animal bed may have any shape shown or described herein, in addition to other shapes. Further, inserts may be designed to be received in any of the cavities or spaces of the bed to provide further configurations. Accordingly, the disclosure is not limited to the configurations described above and shown in the figures, but rather, includes all configurations and their equivalents contemplated herein.

Thus, the present disclosure provides for a modular animal bed with a number of different inserts and support configurations to support animals with different health needs. The embodiments of the beds described herein are customizable to provide for different solutions for different animals and may be sold separately or as a kit (i.e., a base, sidewalls, and one or more inserts together with their respective covers).

In the above description, certain specific details are set forth in order to provide a thorough understanding of various embodiments of the disclosure. However, one skilled in the art will understand that the disclosure may be practiced without these specific details. In other instances, well-known structures associated with animal beds, pads, cushions, and covers have not been described in detail to avoid unnecessarily obscuring the descriptions of the embodiments of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a die may refer to one die. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other derivatives thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the present disclosure.

Generally, unless otherwise indicated, the materials for making the invention and/or its components may be selected from appropriate materials such as fabric, textiles, composite materials, ceramics, plastic, metal, polymers, foam, plastic compounds, and the like.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “left,” “right,” and other like derivatives are used only for discussion purposes based on the orientation of the components in the Figures of the present disclosure. These terms are not limiting with respect to the possible orientations explicitly disclosed, implicitly disclosed, or inherently disclosed in the present disclosure and unless the context clearly dictates otherwise, any of the aspects of the embodiments of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various embodiments described herein, and as such, it is expressly contemplated in the present disclosure to include dimensions that are more or less than the dimensions stated, unless the context clearly dictates otherwise.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above-described embodiments, but should be defined only in accordance with the following claims and their equivalents.

1. A bed, comprising:
a base having a perimeter;
a plurality of sidewalls coupled to the base and extending around the perimeter of the base;
a cavity defined by the plurality of sidewalls and the base; and
an insert in the cavity and extending between two of the plurality of sidewalls to divide the cavity into a first cavity and a second cavity with the insert therebetween,
wherein the plurality of sidewalls and the insert are structured to provide support for an animal laying at least partially in at least one of the first cavity and the second cavity.

2. The bed of claim 1 wherein the base, the plurality of sidewalls, and the insert are foam.

3. The bed of claim 1 further comprising:
a first removable cover on the base and the plurality of sidewalls.

4. The bed of claim 3 further comprising:
a second removable cover on the insert.

5. The bed of claim 1 further comprising:
a pad positionable in the cavity between the plurality of sidewalls and the insert.

6. The bed of claim 5 wherein the pad has a rectangular or square shape with a first surface and a second surface, the first surface proximate the base and the second surface aligned with the plurality of sidewalls.

7. The bed of claim 1 wherein the insert is removable and positionable in the cavity to vary a size of the first cavity and the second cavity.

8. The dog bed of claim 1 wherein the insert is permanently coupled to the plurality of sidewalls, or the base, or both.

9. The dog bed of claim 1 wherein the insert is integral with the base and the plurality of sidewalls as a single, unitary structure.

10. A bed, comprising:
a base;
a plurality of sidewalls coupled to the base, each of the plurality of sidewalls including a first surface and a second surface opposite to the first surface;
a cavity defined by the plurality of sidewalls and the base; and
an insert positionable in the cavity and extending between two of the plurality of sidewalls to separate the cavity into a first cavity and a second cavity, the insert having a first surface positionable on the base and a second surface opposite to the first surface.

11. The bed of claim 10 wherein the second surface of the insert is coplanar with the second surface of the plurality of sidewalls.

12. The bed of claim 10 wherein the second surface of the insert is recessed with respect to the second surface of the plurality of sidewalls.

13. The bed of claim 10 wherein the insert has a cross shape positionable in the cavity between four of the plurality of sidewalls.

14. The bed of claim 10 further comprising:
an aperture in at least one of the plurality of sidewalls, the aperture extending from the second surface of the at least one of the plurality of sidewalls to the base.

15. The bed of claim 10 wherein the insert is permanently coupled to the plurality of sidewalls or the base.

16. The bed of claim 10 wherein the insert is a first insert, the bed further comprising:
a second insert positionable in the first cavity or the second cavity.

17. The bed of claim 16 wherein the second insert is a rectangular divider or a square pad.

18. The bed of claim 16 wherein the second insert has a triangular shape.

19. The bed of claim 10 further comprising:
a removable cover on the base, the plurality of sidewalls, and the insert.

20. The bed of claim 10 further comprising:
a first removable cover on the base and the plurality of sidewalls; and
a second removable cover on the insert.
